(19) United States
(12) Patent Application Publication
(10) Pub. No.: US 2009/0268810 A1
(43) Pub. Date: Oct. 29, 2009

(54) Geometric intra prediction

(76) Inventor: Congxia Dai, San Diego, CA (US)

Correspondence Address: Thomson Licensing LLC, P.O. Box 5312, Two Independence Way, PRINCETON, NJ, 08543-5312, US

(21) Appl. No.: 12/311,100

(22) PCT Filed: Sep. 21, 2007
(86) PCT No.: PCT/US2007/020478

§ 371 Date: Mar. 18, 2009

Related U.S. Application Data
(60) Provisional application No. 60/848,295, filed on Sep. 29, 2006.

(51) Int. Cl. H04N 7/32

(52) U.S. Cl. 375/240.12; 375/E07.243

(57) ABSTRACT

The use of parametric models to capture and represent local signal geometry allows a new geometric intra prediction scheme to better encode video images. The encoding scheme gives the video encoder the flexibility and scalability to match the video frame content with the desired computational complexity. It also allows the encoder to encode the images more efficiently using intra prediction because it reduces the artificial edges that occur during standard intra encoding.

### FIELD OF THE INVENTION

The present invention relates to encoding of digital video information and the compression of that information and relates the coding of the information to geometric information within the image.

### BACKGROUND OF THE INVENTION

In previous video coding standards, such as H.263, MPEG-1/2 and MPEG-4 visual, intra prediction has been conducted in the transform domain. H.264/AVC is the first video coding standard to conduct intra prediction in the spatial domain. It employs directional spatial prediction, extrapolating the edges of the previously decoded parts of the current picture. Though this improves the quality of the prediction signal, thus coding efficiency, compared to previous video coding standards, it is still not optimal in exploiting the geometrical redundancy existing along edges, contours and oriented textures. And, it cannot adapt to various computational complexity requirements. First, the number of intra prediction modes is fixed, so it lacks the adaptation and scalability in matching the video frame content and the computational complexity. Second, due to causality in intra coding, the prediction can create artificial edges which may cause more bits to code the residue.

### SUMMARY OF THE INVENTION

This disclosure proposes a new intra coding scheme to efficiently capture the geometric structure of the image, while exploiting the predictability and/or correlation between neighboring regions and the current region in an image or video picture. Moreover, one or more embodiments of the invention allow for adaptively selecting the amount and/or precision of geometric information, depending on some targeted compression and/or desired algorithm complexity. In this disclosure, we propose a new geometric intra prediction scheme, which aims at solving the issues of adaptability and scalability in matching the video frame content and computational complexity, as well as the problem of artificial edges due to causality in standard intra coding prediction which can cause more bits to be required to encode the residue.

### BRIEF DESCRIPTION OF THE DRAWINGS

Table 1 shows the Intra 4×4 luma prediction modes for H.264.

Table 2 shows the H.264 intra 16×16 luma prediction modes.

Table 3 shows the syntax of the picture parameter set.

Table 4 shows the syntax of macroblock prediction.

FIG. 1 shows the labeling of the prediction samples of a 4×4 block.

FIG. 2 shows the prediction modes for intra 4×4 blocks.

FIG. 3 shows the intra 16×16 luma prediction modes

FIG. 4 shows a first order polynomial used as a parametric model in describing geometry.

FIG. 5 shows a partition mask generated using a first degree polynomial as a parametric model.

FIG. 6 shows an example of a state of the art video codec (i.e. H264 block scheme).

FIG. 7 shows an example of a state of the art video codec (i.e. H264 block scheme) needing changes in order to incorporate the geometric intra prediction mode.

FIG. 8 shows an example of a state of the art video decoder (i.e. H264 block scheme).

FIG. 9 shows an example of a state of the art video decoder (i.e. H264 block scheme) needing changes in order to incorporate the geometric intra prediction mode.

FIG. 10 is the flow chart of an example of encoding one MB using geometric intra prediction.

FIG. 11 is the flow chart of an example of decoding one MB using geometric intra prediction.

### DETAILED DESCRIPTION OF THE PREFERRED EMBODIMENTS

H.264/AVC is the first video coding standard which employs spatial directional prediction for intra coding. This improves the quality of the prediction signal, thus the coding efficiency over previous standards where intra prediction has been done in the transform domain. In H.264/AVC, spatial intra prediction is formed using surrounding available samples, which are previously reconstructed samples available at the decoder within the same slice. For luma samples, intra prediction can be formed on a 4×4 block basis (denoted as Intra_{—}4×4), 8×8 block basis (denoted as Intra_{—}8×8) and for a 16×16 macroblock (denoted as Intra_{—}16×16). In addition to luma prediction, a separate chroma prediction is conducted. There, a total of nine prediction modes for Intra_{—}4×4 and Intra_{—}8×8, four modes for Intra_{—}16×16 and four modes for the chroma component. The encoder typically selects the prediction mode that minimizes the difference between the prediction and original block to be coded. A further intra coding mode, I_PCM, allows the encoder to simply bypass the prediction and transform coding processes. It allows the encoder to precisely represent the values of the samples and place an absolute limit on the number of bits that may be contained in a coded macroblock without constraining decoded image quality.

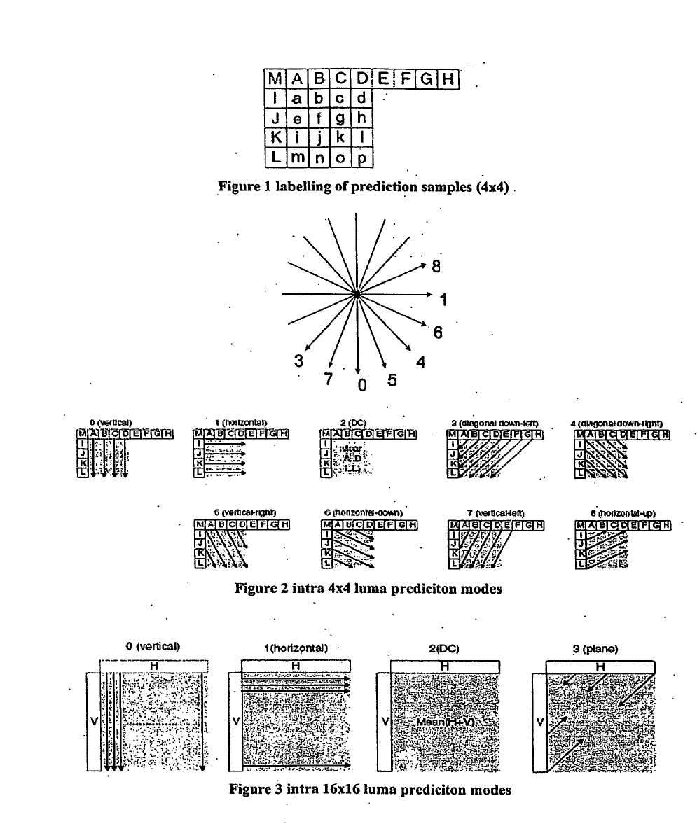

For Intra_{—}4×4, FIG. 1 shows the samples above and to the left (labeled as A-M) which have been previously coded and reconstructed and are therefore available at the encoder and decoder to form the prediction. The samples a, b, c, . . . , p of the prediction block are calculated based on the samples A-M using the prediction mode as shown in FIG. 2 and Table 1. The arrows in FIG. 2 indicate the direction of prediction for each mode. In modes 3-8, the predicted samples are formed from a weighted average of the prediction samples A-M. Intra_{—}8×8 uses basically the same concepts as 4×4 prediction, but with a prediction block size 8×8 and with low-pass filtering of the predictors to improve prediction performance. Four modes are available for Intra_{—}16×16, as shown in FIG. 3 and Table 2. Each 8×8 chroma component of an intra coded macroblock is predicted from previously encoded chroma samples above and/or to the left and both chroma components use the same prediction mode. The four prediction modes are very similar to the Intra_{—}16×16, except that the numbering of the modes is different. The modes are DC (mode 0), horizontal (mode 1), vertical (mode 2) and plane (mode 3).

Though intra prediction in H.264/AVC improves video coding efficiency, it is still not optimal in catching the geometrical redundancy existing along edges, contours and oriented textures. Moreover, present intra prediction techniques in H.264/AVC cannot adapt to the various complexity requirement situations that may be encountered in different applications. First of all, the number of prediction directions is fixed in H.264, so it lacks the adaptation, flexibility and scalability for best matching the very variable video frame content depending on the usable computational complexity and or compression quality. For example, to code the rich variety of edges found in video frames, the predictions may not be precise enough, or too precise, depending on the application, coding quality and/or situation. For a decoder and encoder with different power and/or memory constraints, there is support for more or less modes than currently in H.264/AVC. Second, the asymmetrical characteristics of the intra prediction in H.264 pose constraints of causality. For example, in intra 4×4 prediction mode, as shown in FIG. 2 the accuracy of the prediction for each direction differs because of the scanning/encoding order of the blocks. In the prediction modes such as 0, 1, 4, 5 and 6, the pixels in the target block can be predicted by the nearest boundary pixels. But in the other modes, some of the nearest boundary pixels are not coded and not available, or prediction has to use samples that are farther away. So in the prediction modes such as 3, 7 and 8, the accuracy of the prediction tends to be lower than that in the other modes. These modes may create some artificial edges which may cause more bits to code the residue.

In addition, tree structures have been shown to be sub-optimal for coding image information. Tests indicate that tree-based coding of images is unable to optimally code heterogeneous regions (each region is considered to have a well-defined and uniform characteristic, such as flat, smooth, or stationary texture) separated by a regular (smooth) edge or contour. This problem arises from the fact that tree structures are not able to optimally catch the geometrical redundancy existing along edges, contours or oriented textures. This concept, ported to state of the art video coding strategies, implies that adaptive tree partitioning of macroblocks, even if this is better than simple fixed-size frame partitioning, is still not optimal enough to capture the geometric information contained in two dimensional data for coding purposes. In the previous description of intra coding modes in H.264/AVC, one can clearly see that intra frame partitioning is a tree-based partition structure. Techniques for picture partitioning for image coding have been proposed in order to address the limitation of simple quadtree partition. However, some of the developments just consider “intra” coding of data within the generated “geometric” partitions using simple polynomial representations. These developments are unable to exploit redundancy between neighboring regions as well as to efficiently represent more complex oriented structures than simple edges. Moreover, they lack efficient residual coding for texture encoding.

In this invention, at least one embodiment attempts to solve the disadvantages presented by H.264/AVC intra prediction and the strong limitations of present experimental works in geometric edge coding. Various embodiments of the present invention extend in detail the framework of work in inter picture coding to intra-based prediction coding.

In this invention, the use of parametric models to capture and represent local signal geometry is presented. Given a region or block of a frame to be predicted, a geometric prediction mode is tested in addition to those state-of-art intra prediction modes. The concerned block or region is partitioned into several regions described by one or a set of parametric models. In particular, a form of this can be two partitions where their boundary is described by a parametric model or function ƒ(x,y,\vec{p}), where x and y stand for the coordinate axes, p is the set of parameters containing the information describing the shape of the partition. For example, ƒ(x,y,\vec{p}) may define two partitions separated by a polynomial boundary. Once the frame block or region is divided into partitions using ƒ(x,y,\vec{p}), each generated partition is predicted by the most appropriate predictor, either from neighboring decoded pixels (e.g. in a way that emulates prediction modes in H.264/AVC), by the statistics of the region, and/or by explicit “intra” coding of the partition content using the parameters of some model like, for example, a fitted polynomial (e.g. coding of DC value, plane fitting parameters, etc. . . . ). The selection of all the mode parameters (partition scheme+partitions content description) is subject to a distortion and coding cost measure trade-off optimization. One embodiment of the geometric intra prediction mode in the framework of H.264 works as follows: we first partition a macroblock or a sub-macroblock into two regions where the boundary is described by a parametric model or function ƒ(x,y,\vec{p}). Then we predict each region either from neighboring decoded pixels, by statistics of that region and/or by explicit “intra” coding of the partition content using the parameters of some model like, for example, a fitted polynomial (e.g. coding of DC value, plane fitting parameters, etc. . . . ), followed by residual coding. Finally, we compute the distortion measure. The mode is selected only if it outperforms standard H.264 intra prediction modes in the sense of a rate-distortion measure.

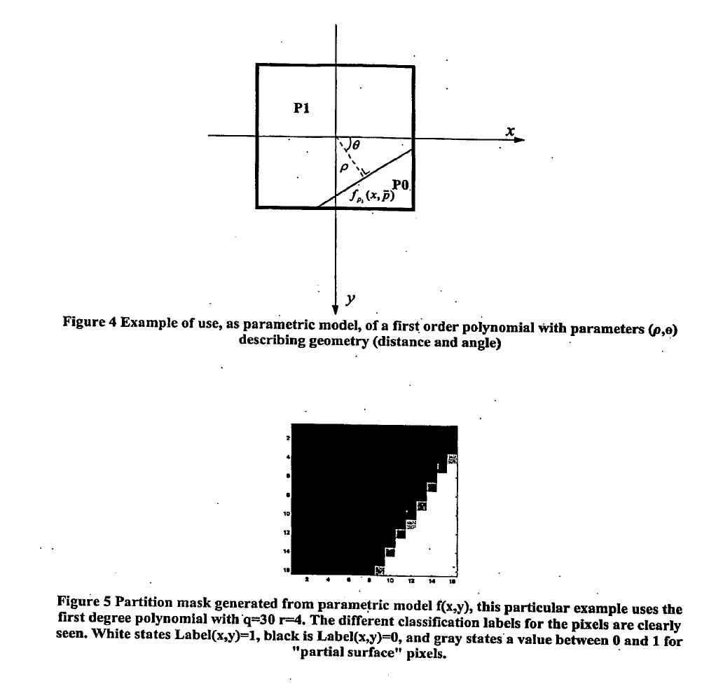

The boundary between two partitions can be modeled and finely approximated by some kind of polynomial ƒₚ(x,y,\vec{p}) (also expressed as ƒ(x,y) in the following), which can be operated such that it describes geometric information such as local angle, position and/or some sort of curvature. Hence, in the particular case of a first order polynomial, we can describe the partition boundary (shown in FIG. 4) as

ƒ(x,y)=x cos θ+y sin θ−ρ,

where the partition boundary is defined over those positions (x,y) such that ƒ(x,y)=0. The partition mask (shown in FIG. 5) is defined as

$$GEO\_Partition = \{ \begin{matrix}if f ( x , y ) > 0 & Partition 0 \\ if f ( x , y ) = 0 & Line Boundary \\ if f ( x , y ) < 0 & Partition 1\end{matrix}$$

All pixels located on one side of the zero line (ƒ(x,y)=0) are classified as belonging to one partition region (e.g. Partition 1). All pixels located at the other side, are classified in the alternative region (e.g. Partition 0).

For each partition, we can fill the prediction using available information from one of the following ways.
1) Prediction from neighboring decoded pixels, e.g. directional prediction DC prediction and/or plane prediction. In directional prediction, prediction direction can be the same or different from the direction of partition edges.
2) Prediction by the statistics inside the region. It can be a DC value, a fitting plane inside the region or a higher order model.
3) A patch searched from the decoded image regions.
   At the encoder, an exhaustive search based on some distortion measure, or some fast algorithm, for example, based on statistics, can be used to decide with prediction should be used.

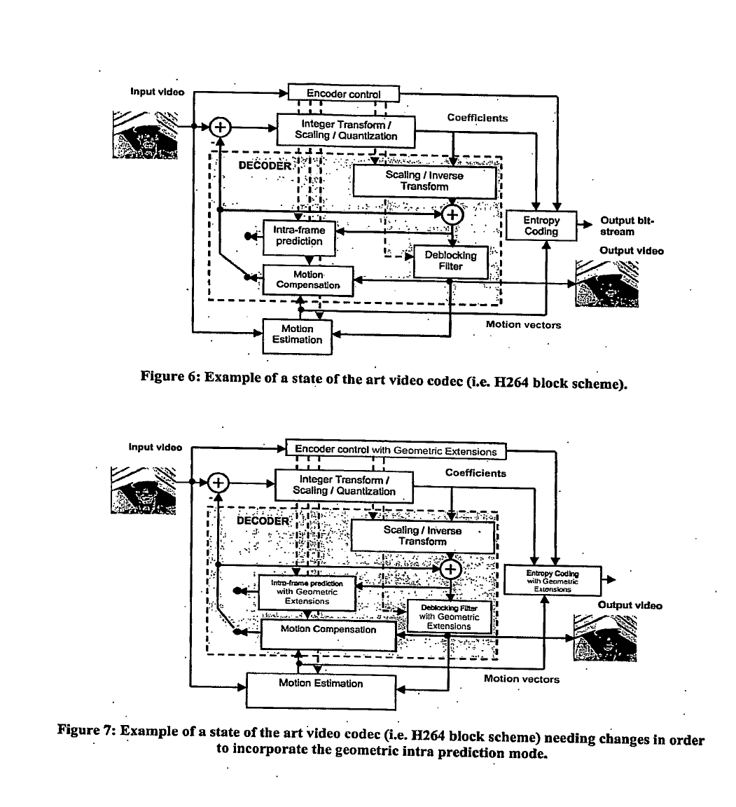

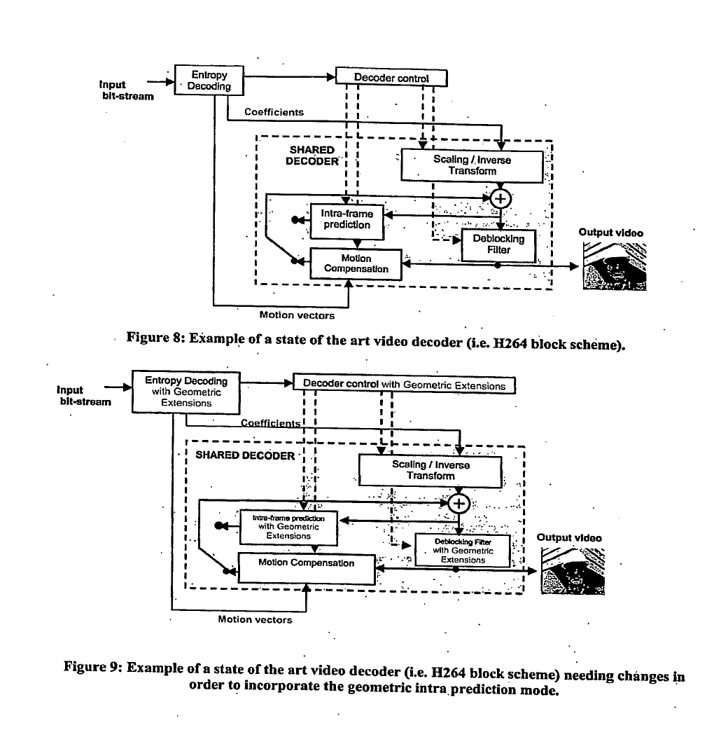

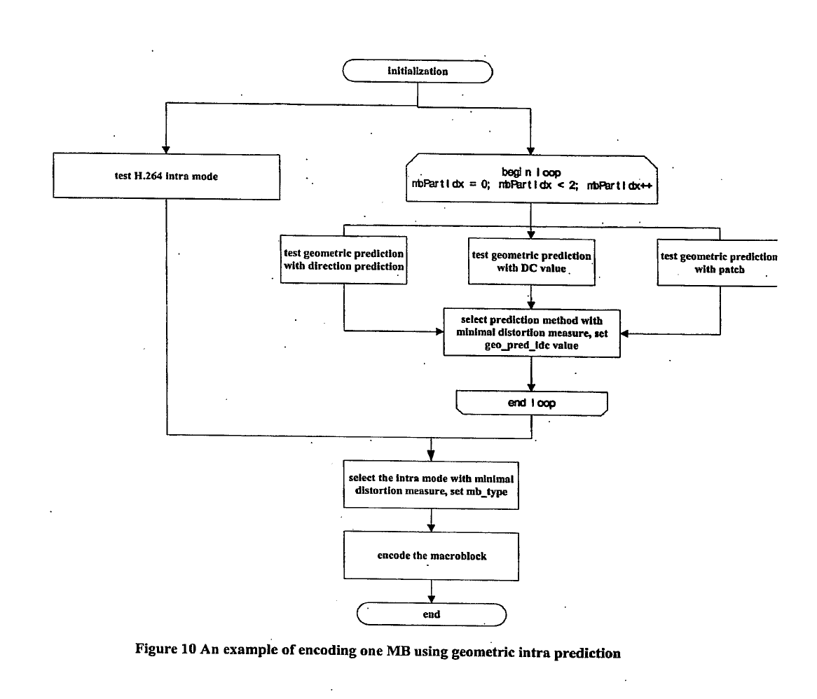

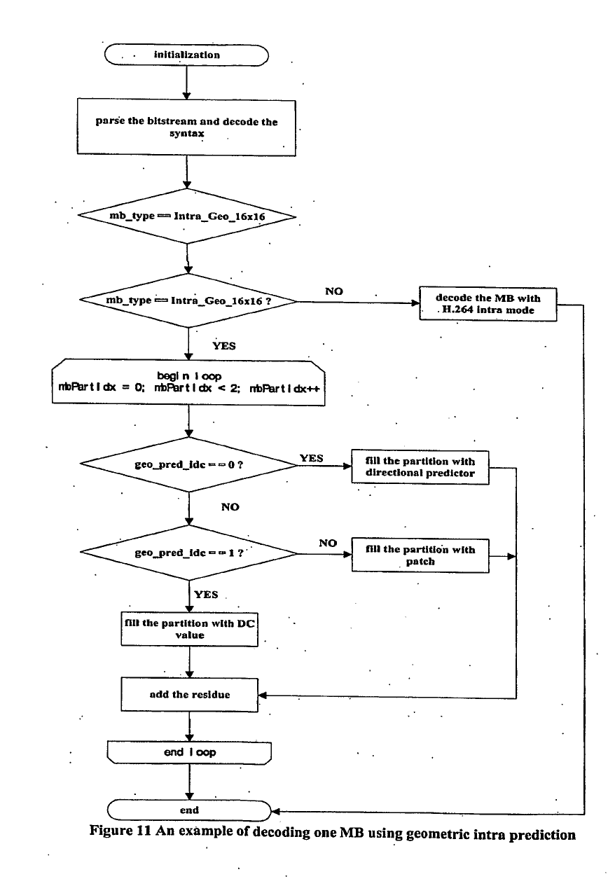

In one particular case of our invention within the framework of H.264, we add the geometric intra prediction mode (named as Intra_Geo_{—}16×16) for macroblock, where the mode is inserted after intra4×4 but before intra16×16. The geometric boundary is presented using a line, where we code the distance (ρ) and angle (θ). We can code (ρ,θ) jointly or independently. The (ρ,θ) can be absolutely coded or differentially coded using neighboring information. The precision of partition can be controlled by quantization step size for distance and quantization step size for angle, which can be signaled in high level syntax, such as sequence parameter set, picture parameter set, or a slice header. For each partition, an indicator is specified on which method is used to fill the prediction. If the directional prediction from neighboring decoded pixels is used, we need to code the direction. If we fill the partition with statistics and/or by explicit “intra” coding of the partition content using the parameters of some model like inside the block, we need to code, for example, the DC value or the plane information. If we fill the partition with the patch, we need to code the equivalent of “motion” vectors. An example of syntax is shown in Table 3 and Table 4.
qs_for_distance specifies the quantization step size for distance.
qs_for_angle specifies the quantization step size for angle.
quant_distance_index specifies the index of quantized distance. When multiplied by qs_for_distance, it gives quantized distance.
quant_angle_index specifies the index of quantized angle. When multiplied by qs_for_angle, it gives quantized angle.
geo_pred_idc specifies the indication of geometric prediction in the partition. For geo_pred_idc equal to 0, the directional prediction is used. For geo_pred_idc equal to 1, the DC value is used. For geo_pred_idc equal to 2, the patch is used.
directional_pred_mode specifies the directional prediction mode, which identifies the prediction direction.
dc_pred_value specifies the DC prediction value.
mvdx specifies the motion vector difference for x.
mvdy specifies the motion vector difference for y.
   FIG. 6 shows an example of a state of the art video codec (i.e. H264 block scheme). FIG. 7 shows an example of a state of the art video codec (i.e. H264 block scheme) needing changes in order to incorporate the geometric intra prediction mode. FIG. 8 shows an example of a state of the art video decoder (i.e. H264 block scheme). FIG. 9 shows an example of a state of the art video decoder (i.e. H264 block scheme) needing changes in order to incorporate the geometric intra prediction mode. FIG. 10 is the flow chart of an example of encoding one MB using geometric intra prediction. FIG. 11 is the flow chart of an example of decoding one MB using geometric intra prediction.

TABLE 1
H.264 Intra 4 × 4 luma prediction modes

| | |
|---|---|
| Mode 0 (Vertical) | The upper samples A, B, C, D are extrapolated |
| | vertically. |
| Mode 1 (Horizontal) | The left samples I, J, K, L are extrapolated |
| | horizontally. |
| Mode 2 (DC) | All samples in P are predicted by the mean of |
| | samples A . . . D and I . . . L. |
| Mode 3 (Diagonal | The samples are interpolated at a 45° angle |
| Down-Left) | between lower-left and upper-right. |
| Mode 4 (Diagonal | The samples are extrapolated at a 45° angle |
| Down-Right) | down and to the right. |
| Mode 5 (Vertical- | Extrapolation at an angle of approximately 26.6° |
| Right) | to the left of vertical (width/height = ½). |
| Mode 6 (Horizontal- | Extrapolation at an angle of approximately 26.6° |
| Down) | below horizontal. |
| Mode 7 (Vertical- | Extrapolation (or interpolation) at an angle of |
| Left) | approximately 26.6° to the right of vertical. |
| Mode 8 (Horizontal- | Interpolation at an angle of approximately 26.6° |
| Up) | above horizontal. |

TABLE 2
H.264 intra 16 × 16 luma prediction modes

| | |
|---|---|
| Mode 0 (vertical) | Extrapolation from upper samples (H) |
| Mode 1 | Extrapolation from left samples (V) |
| (horizontal) | |
| Mode 2 (DC) | Mean of upper and left-hand samples (H + V). |
| Mode 4 (Plane) | A linear ‘plane’ function is fitted to the upper |
| | and left-hand samples H and V. This works well |
| | in areas of smoothly-varying luminance. |

TABLE 3
syntax of picture parameter set

| pic_parameter_set_rbsp( ) { | C | Descriptor |
|---|---|---|
| ... | | |
| qs_for_distance | 1 | u(v) |
| qs_for_angle | 1 | u(v) |
| ... | | |
| } | | |

TABLE 4
syntax of macroblock prediction

| mb_pred(mb_type ) { | C | Descriptor |
|---|---|---|
| ... | | |
| if( MbPartPredMode( mb_type, 0 ) == | 2 | u(1) |
| Intra_Geo_16×16 ) { | | |
| quant_distance_index | 2 | u(v)\|ae(v) |
| quant_angle_index | 2 | u(v)\|ae(v) |
| for( mbPartIdx = 0; mbPartIdx < 2; | | |
| mbPartIdx++ ) { | | |
| geo_pred_idc | 2 | u(2)\|ae(v) |
| if (geo_pred_idc == 0) | | |
| directional_pred_mode | 2 | u(v)\|ae(v) |
| else if (geo_pred_idc == 1) | | |
| dc_pred_value | 2 | u(8)\|ae(v) |
| else { | | |
| mvdx | 2 | se(v)\|ae(v) |
| mvdy | 2 | se(v)\|ae(v) |
| } | | |
| } | | |
| } | | |
| ... | | |
| } | | |

1. A video encoder wherein groups of pixels can be divided into partitions of arbitrary shape, each of said partitions being filled with prediction data from intra-coded image data and/or an explicit description based on model fitting.

2. The video encoder of claim 1 wherein said arbitrary shape is described by means of one or several parametric models or functions.

3. The video encoder of claim 2 wherein a polynomial is used for said parametric model or function.

4. The video encoder of claim 3 wherein a first order polynomial model is used for said polynomial.

5. The video encoder of claim 4 wherein said polynomial comprises the two parameters of angle and distance.

6. The video encoder of claim 1 wherein said model comprises a parameter that is adapted to control compression efficiency and/or encoder complexity.

7. The video encoder of claim 1 wherein said prediction data associated with each partition is predicted from decoded pixels or from statistics inside said partition.

8. The video encoder of claim 7 wherein said prediction is performed using at least one of either directional prediction, DC prediction or plane prediction.

9. Claim 8 wherein the direction of said directional prediction can be the same or different as said partition direction.

10. The video encoder of claim 7 wherein a patch searched from said decoded image region is used as a prediction.

11. The video encoder of claim 7 wherein said statistics can be chosen from the list that includes DC value, a fitting plane and a high order model.

12. The video encoder of claim 1 wherein said prediction and encoding is based on an extension of H.264.

13. The video encoder of claim 12 wherein a parametric model based intra-coding mode can be applied to macroblocks or sub-macroblocks.

14. The video encoder of claim 1 wherein the precision of parameters within said model is conveyed in a sequence parameter set, picture parameter set, slice header, or derived from other coding parameters.

15. The video encoder of claim 14 wherein said parameters of said model describing a partition boundary can be coded and conveyed in a sequence parameter set, picture parameter set, or slice header.

16. The video encoder of claim 7 wherein a codeword indicating which prediction method is used can be signaled in macroblock prediction data.

17. The video encoder of claim 8 wherein said direction can be signaled in macroblock prediction data.

18. The video encoder of claim 10 wherein a motion vector is coded within macroblock prediction data.

19. The video encoder of claim 11 wherein DC, plane information and/or a higher order model can be coded within macroblock prediction data.

20. The video encoder of claim 1 wherein said model parameters and said partition predictions are selected in order to jointly minimize some distortion measure and/or coding cost measure.

21. The video encoder of claim 1 wherein said model parameters and said partitions prediction are selected according to statistics of said image region.
